(19) United States
(12) Patent Application Publication
(10) Pub. No.: US 2004/0252017 A1
(43) Pub. Date: Dec. 16, 2004

(54) Secure home delivery system

(76) Inventors: Andrew Christopher Holding, Cheltenham (GB); Thomas Bernard Jarman, Selsley (GB)

Correspondence Address: Andrew Holding, 346 Old Bath Road, Cheltenham Gouceshire, GL53 9AF, GB

(21) Appl. No.: 10/332,227

(22) PCT Filed: Jun. 29, 2001
(86) PCT No.: PCT/GB01/02908

(30) Foreign Application Priority Data
Jul. 6, 2000 (GB) GB0016576.1

(51) Int. Cl. G06F 17/12

(52) U.S. Cl. 340/5.73; 340/5.26; 340/5.28; 340/5.9

(57) ABSTRACT

Secure Home Delivery SystemA system for providing secure delivery or collection of goods too large to be delivered through traditional apertures such as the letterbox, to a location, such as a home, where the goods have previously been remotely ordered using remote means such as the internet or telephone. Access to a secure location, for example, a dedicated receptacle, garage or shed, is achieved by presentation of an access code by the delivery personnel, the origin of which is linked to the order of the goods. The access code may be computed using time-based algorithms that are replicated by the lock at the delivery location, unlocking occurring when the access codes coincide. The lock can provide access to a key safe, which in turns holds keys to a secure location. The system could equally be used for the collection of goods and for providing access to utility meters.

This invention relates to a system for providing secure delivery of goods to a buyer at a location, such as a home, where the goods have previously been ordered using some remote means such as the Internet or phone. It provides a secure means of delivery of those goods too large to be received by the normal means such as a letterbox, without the need for the occupiers to be present in order to receive the goods. Variants of the invention provide for the collection of goods or data from a property or the use of the lock involved for authorised access in other circumstances.

Currently when ordering goods for delivery to the home by such means as the internet or telephone, it is often the case that the goods to be delivered are larger than the normal aperture (letterbox) or receptacle provided to accept such goods. If, therefore, the buyer of these goods is not available to take receipt of these goods, delivery is either not possible or results in a situation where the goods are left at the address where they are then at risk from theft or the weather. Alternatively, new arrangements have to be made for the exchange of the goods. This could include the intended recipient travelling to a central distribution point to collect the goods or rearranging a mutually acceptable time to personally receive the goods at the intended delivery address. These situations generally suit neither buyer nor supplier and significantly limit the benefits of this mode of shopping by restricting the process to small items, which can be reliably and securely delivered or by restricting the movements of the buyer.

The invention overcomes this problem of the delivery of goods by providing a means of authorised access for delivery staff to a secure location; the means of access being securely linked to the original order for the goods or instruction for secure access to be gained. This process of delivery would not require the buyer, or recipient of the goods, to be present at the time of delivery.

According to one aspect of the present invention there is provided a system for allowing delivery of goods to a storage facility, the system including:

lock means for controlling access to the storage facility, the lock means having a memory capable of storing data relating to at least one valid security code and being configured to unlock upon presentation of a valid security code, and

security code supply means located remotely from the storage facility,

wherein the security code supply means transfers data relating to a valid security code for the storage facility directly or indirectly to a delivery person, thereby allowing the delivery person to present the valid security code to the lock means to unlock it and access the storage facility.

The storage facility may be a building, an enclosure or a container such as a safe. The storage facility is preferably used for delivering goods and storing them until they are collected. By “delivery person” it is meant a person who is intended to deposit one or more item in the storage facility. A delivery person may be an individual or an organisation responsible for the delivery of the goods.

Alternatively the lock means may control access to the storage facility indirectly, by allowing access to a receptacle containing a key or keys, said key or keys allowing access to the storage facility used for the storage of the delivered goods. The receptacle may be fixed to an external wall. The receptacle, due to its smaller size, may be unsuited to receive many goods itself, this can be defined by the limitation that it cannot store a package of dimensions of 250 mm×250 mm×250 mm.

The lock means and the security code supply means may each include a respective processor for generating data relating to the valid security code. The valid security code may be generated according to an algorithm. The lock means algorithm and the security code supply means algorithm may be substantially identical, or one may complement the other. The algorithm may include time related values, for example, the valid security code may be a newly generated value (e.g. a pseudo random value) generated at regular intervals. Alternatively, the valid security code may represent a time counter running from an initial point in time synchronised for both the lock means and the security code supply means. For increased accuracy, the lock means and/or the security code supply means may obtain time data from an external source, for example, via a radio link to an atomic clock.

Alternatively, the algorithm may update the valid security code after it has been presented to the lock means a preset number of times.

The lock means may further include means for deleting or amending data relating to the valid security code after a preset period of time.

In one embodiment the lock means further includes means for a user (i.e. normally a person who is intended to collect delivered goods from the storage facility or the owner or leasee of the storage facility) of the storage facility to enter at least one value into the lock means memory. The user-entered value may include the valid security code or other information which can be used by the algorithm to generate the valid security code. The user value entry means may be a keypad, a remote control or a modem, including a wireless modem. In some cases the delivery person could receive the security code data from a voice over a telephone fine. Alternatively the delivery person may have a communication device such as a mobile phone configured to receive a text message or a Wireless Application Protocol (VVAP) device capable of receiving and transmitting data signals. Such a device could also be used to present the valid security code data to a suitable receiver on the lock means. The lock means may further include means for transferring data stored in its memory to the security code supply means. This can allow the user-entered values to be used by the security supply code means processor, for example, acting as a key for the code generation algorithm.

The means for presenting the valid security code to the lock means may include an electronic device having a memory storing data relating to the valid security code, the device further including an interface for transferring the data from its memory to the lock means.

The lock means memory may further store data relating to a specific delivery of goods, each said specific delivery having a corresponding valid security code. Thus, each said specific delivery can have a unique valid security code, which can reduce the risk of a dishonest delivery to person subsequently accessing the storage facility without authorisation. The lock means may further include means for amending or deleting the stored data relating to a specific delivery after the valid security code corresponding to that delivery has been presented to the lock means. This can be used to record that the specific delivery has taken place. The lock means may further include means for transferring the data relating to a specific delivery, for example, to the security code supply means. The specific delivery data may include a value identifying the delivery person who presented the valid security code to the lock means.

The system may be linked, directly or indirectly, to the ordering event by the customer. The customer may order over the phone or utilising the internet. In this case information may pass from the customer to the security code supply means which is linked to the generation of the valid security code.

Some delivery companies may require confirmation from the customer that the storage facility has been accessed. The customer may place some form of authorised goods receipt acknowledgement in the receptacle for the delivery person to access once the valid security code has been presented.

According to another aspect of the present invention there is provided a method of allowing goods to be delivered to a storage facility, the method including steps of:

storing data relating to at least one valid security code in a lock means for controlling access to the storage facility;

supplying data relating to the valid security code from a location remote from the storage facility directly or indirectly to a delivery person requiring access to the storage facility;

the delivery person presenting a security code to the lock means;

the lock means comparing the presented security code with, the valid security code data, and

the lock means unlocking if the comparison is positive, thereby allowing the delivery person to access the storage facility.

According to yet another aspect of the present invention there is provided a storage facility for goods, the storage facility including:

lock means for controlling access to the storage facility, the lock means having a memory capable of storing data relating at least one valid security code and being configured to unlock upon presentation of a valid security code,

means for receiving a security code;

means for comparing the received security code with the valid security code data, and means for unlocking the lock means if the comparison is positive,

wherein the received security code is presented to the lock means by a delivery person who has obtained the security code directly or indirectly from a remotely located security code supply means.

The storage facility may include a container suitable for storing keys. The container may be fixed to an external wall.

The storage facility may further include means for a user of the storage facility to enter at least one value into the lock means memory. The lock means memory may include a steady state memory or micro-switches.

According to a further aspect of the present invention there is provided apparatus for supplying data relating to a security code for a storage facility to a delivery person, the code supply apparatus including:

memory means for storing data relating to at least one valid security code corresponding to a remotely located storage facility, and

means for transferring the data relating to the valid security code directly or indirectly to a delivery person requiring access to the storage facility, thereby allowing the delivery person to present the valid security code to a lock means on the storage facility.

The means for transferring the data relating to the valid security code may include a telephone, a communications network interface such as a network card or modem, or a wireless link.

According to a further aspect still of the present invention there is provided a system for allowing access to a storage facility, the system including:

lock means for controlling access to the storage facility, the lock means having a memory capable of storing data relating to at least one valid security code and being configured to unlock upon presentation of a valid security code, and

security code supply means located remotely from the storage facility,

wherein the code supply means transfers data relating to a valid security code far the storage facility directly or indirectly to a person requiring access, thereby allowing the person to present the valid security code to the lock means to unlock it and access the storage facility.

The invention also extends to a method of allowing access to a storage facility.

The storage facility may house objects such as utility meters.

According to a particular aspect of the present invention, there is provided a system for the delivery of goods, said system including a lock, a computing facility consisting of at least one computer and a delivery event;

said lock being located at the premises being delivered to, and having at least one means for unlocking with an operation code that changes;

said computing facility being sit remotely from the lock and storing sufficient information to provide, directly or indirectly, said unlock code,

said delivery event including the delivery of goods to said premises by an authorised person with a means to input said unlock code to the lock;

where the said delivery event includes the unlocking of said lock by said authorised person using a means or code provided directly or indirectly by said computer.

The system may be initiated by an order ever, said order event providing a link to said computer that authorises the use of said lock operation code. The lock operation code may have a limited duration of operation, the limiation may be by time or by number of operations. The lock operation code may be manually encoded into said lock or encoded using a wire or wireless link. The lock operation code may be self-generated in a manner that can be anticipated or computed by said computer and the lock may have an identity characteristic known to said computer. Within the system, the lock may have a time tracking means that is or can be known to said computer to an uncertainty equivalent to or better than ±1 month or its equivalent duration. The lock operation code maybe activated by said authorised person via a keypad or may be via a key programmed directly or indirectly by said computer. The key may be valid for use on a limited and defined number of occasions. The lock may be unlocked by the use of said lock operation code and one of a limited number of authorisation codes. The lock may be integrat to a small box, a key safe, suitable for storing keys wich may be provided with a method for securely fixing it to an external wall. The lock may provide acoess to a house, shed, garage or other suitable storage location at said premises. The lock may have a method for storing data as to whom or whic th key operated said lock. The delivery system may operate a database or series of databases of said locks, said delivery events or said orders, and said premises or owners.

According to another aspect of the present invention, there is provided a lock for the control of access to a physical location, said lock may include a microprocessor and may have at least one means for unlocking with an operation code that changes; said lock may have a time tracking means that may be known to said computer to an uncertainty equivalent or better than ±1 month or an equivalent duration; where the lock operation code may be self-generated in a manner that can be anticipated or computed by said computer. The lock may have an identity characteristic known to said computer, (which may take the form of a code or a known offset of the time tracking means to an external time such as Greenwich Mean Time) and may have a limited duration of operations, the limitation may be by time or by number of operations. The lock operation code may be activated by said authorised person via a keypad. The lock operation code may be activated by said authorised person via a key programmed directly or indirectly by said computer. The key may be valid for use on a limited number of occasions The lock may be unlocked by the use of said lock operation code and one of a limited number of authorisation codes. The lock may be integral to a small box, a key safe, suitable for storing household keys. The key safe may have a method for securely fixing it to an external wall. The lock may provide access to a house, shed, garage or other suitable storage location at said premises. The lock may have a method for storing data as to whom or which key operated said lock.

According to yet another aspect of the present invert there is provided a system for enabling the access of a suitably authorised person to a property or location at a property when the normal occupiers of the property are not present, said system including a lock and a computer:

said lock having at least one means for unlocking with an operation code that changes;

said computer being situated remotely from the lock and storing sufficient information to provide, directly or indirectly, said unlock code;

said authorised person with a means to input said unlock code to the lock;

where unlocking is done by the authorised person using a means or code provided directly or indirectly by said computer. The lock operation code may have a limited duration of operation, the limitation may be by time or by number of operations. The lock operation code may be manually encoded into said lock. The lock operation code may be encoded into said lock using a wire or wireless link. The lock operation code may be self-generated in a manner that can be anticipated or computed by said computer. The lock may have an identity characteristic known to said computer. The lock may have a time tracking means that may be known to said computer to an uncertainty equivalent to or better than ±1 month. The lock operation code may be activated by said authorised person via a keypad. The lock operation code may be activated by said authorised person via a key programmed directly or indirectly by said computer. The key may be valid for use on a limited number of occasions. The lock may be unlocked by the use of said lock operation code and one of a limited number of authorisation codes. The lock may be integral to a small box, a key safe, suitable for storing household keys. The key safe may have a method for securely fixing it to an external wall. The lock may provide access to a house, shed, garage or other suitable storage location at said premises. The lock may have a method for storing data as to whom or which key operated said lock.

The computer may operate a database or series of databases of said locks or/and said premises or said occupiers. The database may include a record of who could authorise access and may include at least one password or other code, which may be given to authorise access. The lock may provide access for collection of material, goods or data from the property.

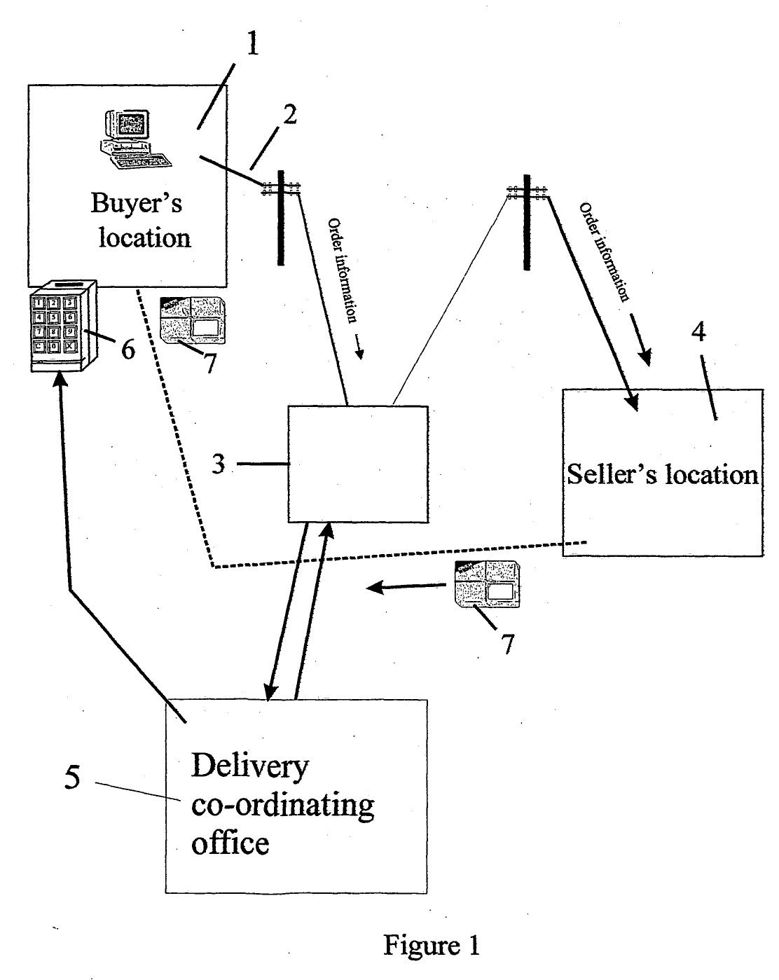

According to another aspect of the present invention, there is provided a secure home delivery system substantially as described herein with reference to FIGS. 1-3 of the accompanying drawings.

A specific embodiment of the invention will now be described with reference to the accompanying drawings in which:

FIG. 1 shows a schematic overview of a purchasing/supply cycle

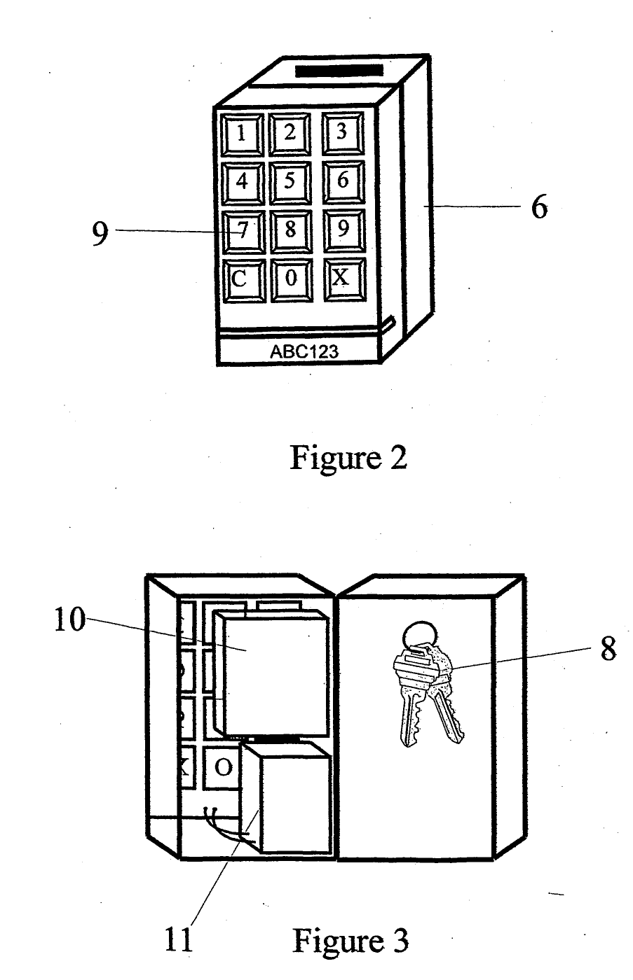

FIG. 2 shows a view of the lock

FIG. 3 shows a view of the internal layout of the lock

As shown in FIG. 1 the order process starts in the buyer's premises 1 using, for example, a personal computer linked to a telephone line 2 The buyer places an order for some goods for delivery from a supplier 4 by completing the appropriate on-screen information fields and by providing sufficient credit card information to enable the supplier to receive payment for the goods 7. In addition, the buyer selects an option to authorise the secure home delivery option as the means of delivery of the goods, assuming that registration of the buyer's system has already taken place.

The seller initiates delivery, receipt of monies and authorises the controlling computer 3 to release a special code upon delivery. The authorised person arrives at the goods' destination address 1 with the goods 7 and calls his delivery co-ordinating office 5. The office communicates with the computer 3 (perhaps by Internet) which checks authorisation (correct delivery company at the correct house at the correct time). If authorised, a special code for the key safe 6 is given to the office corresponding to the time of the delivery.

This numerical code is communicated by the office to the authorised person, who uses it to open the key safe 6 via the keypad 9. This releases a key 8 that he uses to open the suitable store, say a garage. He places the goods 7 in the garage, perhaps putting frozen items into a freezer in the garage. He then secures the garage and replaces the key 8 in the key safe 6.

Th Key Safe 6

Box: Large enough to take keys and small set of instructions.

Keypad 9: Numbered 0-9 (clear) O (open)

Memory Chip 10: The Lock's identity code

Clock 10: Initialised at manufacture. Battery backed 11; lasts say five years with accuracy better than ±15 minutes. Time, day, date. (or could have radio or mains synchronisation)

Microprocessor 10: Generates a Special Code for every hour, based on a manipulation of the time and Lock identity code. The Special Code will only operate the lock for the designated hour and for one hour before and after. (To allow for slight lack of time synchronisation)

The Computer—3

Database: All owners of Locks with location and Lock identity codes.

Clock. Synchronised to the clocks on all installed Locks

Order data: Knowledge of which Householder has authorised which Delivery.

Microprocessor Generates the Special Code corresponding to particular Lock at a particular Time.

1. A system for allowing delivery of goods to a storage facility, the system including:
lock means for controlling access to the storage facility, the lock means having a memory capable of storing data relating to at least one valid security code and being configured to unlock upon presentation of a valid security code, and
security code supply means located remotely from the storage facility,
wherein the security code supply means transfers data relating to a valid security code for the storage facility directly or indirectly to a delivery person, thereby allowing the delivery person to present the valid security code to the lock means to unlock it and access the storage facility.

2. A system according to claim 1, wherein the lock means controls access to a receptacle containing a key or keys, said key or keys allowing access to the storage facility used for the storage of the delivered goods.

3. A system according to claim 1 or 2, wherein the lock means and the security code supply means each include a respective processor for generating data relating to the valid security code according to a series of executable steps.

4. A system according to claim 3, wherein the series of executable steps includes time related values.

5. A system according to claim 4, wherein the valid security code is updated at intervals.

6. A system according to claim 4, wherein the valid security code represents a time counter running from an initial point in time.

7. A system according to any one of claims 4 to 6, wherein the lock means further includes means for obtaining time data from an external source.

8. A system according to any one of the preceding claims, wherein the lock means further includes means for amending or deleting data relating to the valid security code after a preset period of time.

9. A system according to any one of the claims 2 to 8, wherein the series of executable steps updates the valid security code after it has been presented to the lock means a preset number of times.

10. A system according to anyone of the preceding claims, wherein the lock means further includes means for a user of the storage facility to enter at least one value into the lock means memory.

11. A system according to claim 10, wherein the user value entry means includes a keypad.

12. A system according to claim 10, wherein the user value entry means includes a communications network interface.

13. A system according to any one of claims 10 to 12, wherein the user entered value is used by the valid security code generation series of executable steps.

14. A system according to anyone of the preceding claims, wherein the lock means memory further stores data relating to a specific delivery of goods, each said specific delivery having a corresponding valid security code.

15. A system according to claim 14, wherein the lock means further includes means for amending or deleting the stored data relating to a specific delivery after the valid security code corresponding to that delivery has been presented to the lock means.

16. A system according to any one of the preceding claims, wherein the lock means further includes means for transferring data stored in its memory to a remote location.

17. A system according to claim 15 or 16, wherein the specific delivery data includes a value identifying the delivery person who presented the valid security code corresponding to that specific delivery to the lock means.

18. A system according to claim 2 wherein the receptacle is fixed to an external wall.

19. A system according to claim 2 or 18 wherein the receptacle is unsuited to the storage of many goods in that it cannot contain a cube shaped package of dimensions 250 mm×250 mm×250 mm.

20. A system according to claim 2, claim 18 or claim 19 wherein the receptacle occasionally contains an authorised goods receipt acknowledgement.

21. A system according to any of the previous claims wherein the generation of the valid security code from the security code supply means is linked, directly or indirectly, to the means for customer ordering of said goods.

22. A method of allowing goods to be delivered to a storage facility, the method including steps of:
storing data relating to at least one valid security code in a lock means for controlling access to the storage facility;
supplying data relating to the valid security code from a location remote from the storage facility to a delivery person requiring access to the storage facility;
the delivery person presenting a security code to the lock means;
the lock means comparing the received security code with the valid security code data, and
the lock means unlocking if the comparison is positive, thereby allowing the delivery person to access the storage facility.

23. A storage facility for goods, the storage facility including:
lock means for controlling access to the storage facility, the lock means having a memory capable of storing data relating to at least one valid security code and being configured to unlock upon presentation of a valid security code;
means for receiving a security code;
means for comparing the received security code with the valid security code data, and
means for unlocking the lock means if the comparison is positive,
wherein the received security code is presented to the lock means by a delivery person who has obtained the security code directly or indirectly from a remotely located security code supply means.

24. A storage facility according to claim 23, wherein the storage facility includes a container suitable for storing keys.

25. A storage facility according to claim 24, wherein the container is fixed to a wall.

26. Apparatus for supplying data relating to a security code to a delivery person requiring access to a storage facility, the code supply apparatus including:
memory means for storing data relating to at least one valid security code corresponding to a remotely located storage facility, and
means for transferring the data relating to the valid security code directly or indirectly to a delivery person requiring access to the storage facility, thereby allowing the delivery person to present the valid security code to a lock means on the storage facility.

27. Apparatus according to claim 26, wherein the means for transferring the data relating to the valid security code includes a communications network interface.

28. A system for allowing access to a storage facility, the system including:
lock means for controlling access to the storage facility, the lock means having a memory capable of storing data relating to at least one valid security code and being configured to unlock upon presentation of a valid security code, and
security code supply means located remotely from the storage facility,
wherein the security code supply means transfers data relating to a valid security code for the storage facility directly or indirectly to a person requiring access, thereby allowing the person to present the valid security code to the lock means to unlock it and to access the storage facility.

29. A method of allowing access to a storage facility, the method including steps of:
storing data relating to at least one valid security code in a lock means for controlling access to the storage facility;
supplying data relating to the valid security code from a location remote from the storage facility to a person requiring access to the storage facility;
the person presenting a security code to the lock means;
the lock means comparing the received security code with the valid security code data, and
the lock means unlocking if the comparison is positive, thereby allowing the person to access the storage facility.

30. A system for the delivery of goods, said system including a lock, a computing means and a delivery event;
said lock being located at the premises being delivered to, and having at least one means for unlocking with an operation code that changes;
said computing means being situated remotely from the lock and storing sufficient information to provide, directly or indirectly, said unlock code;
said delivery event including the delivery of goods to said premises by an authorised person with a means to input said unlock code to the lock;
where the said delivery event includes the unlocking of said lock by said authorised person using a means or code provided directly or indirectly by said computing means.

31. A system for the delivery of goods according to claim 30 that is initiated by an order event, said order event providing a link to said computing means that authorises the use of said lock operation code.

32. A system for the delivery of goods according to claim 30 or 31 where the said lock operation code has a limited duration of operation, the limitation may be by time or by number of operations.

33. A system for the delivery of goods according to any one of claims 30 to 32 where the said lock operation code is manually encoded into said lock.

34. A system for the delivery of goods according to any one of claims 30 to 32 where said lock operation code is encoded into said lock using a wire or wireless link.

35. A system for the delivery of goods according to any one of claims 30 to 32 where said lock operation code is self-generated in a manner that can be anticipated or computed by said computing means.

36. A system for the delivery of goods according to any one of claims 33 to 35 where said lock has an identity characteristic known to said computing means.

37. A system for the delivery of goods according to any one of claims 30 to 36 where said lock has a time tracking means that is or can be known to said computing means to an uncertainty equivalent to or better than +I-1 month or its equivalent duration.

38. A system for the delivery of goods according to any of claims 30 to 37 where said lock operation code is activated by said authorised person via a keypad.

39. A system for the delivery of goods according to any of claims 30 to 37 where said lock operation code is activated by said authorised person via a key programmed directly or indirectly by said computing means.

40. A system for the delivery of goods according to claim 39 where said key is valid for use on a limited number of occasions.

41. A system for the delivery of goods according to any of claims 30 to 40 where said lock is unlocked by the use of said lock operation code and one of a limited number of authorisation codes.

42. A system for the delivery of goods according to any of claims 30 to 41 where said lock is integral to a small box, a key safe, suitable for storing keys.

43. A system for the delivery of goods according to claim 40 or 41 where said key safe has a method for securely fixing it to an external wall.

44. A system for the delivery of goods according to any of claims 40 to 43 where said lock can provide access to a house, shed, garage or other suitable storage location at said premises.

45. A system for the delivery of goods according to any of claims 30 to 44 where said lock has a method for storing data as to whom or which key operated said lock.

46. A system for the delivery of goods according to any of claims 30 to 45 where said computing means operates a database or series of databases of said locks, said delivery events or said orders, and said premises or owners.

47. A lock for the control of access to a physical location, said lock including a microprocessor and having at least one means for unlocking with an operation code that changes;
said lock having a time tracking means that is or can be known to said computing means to an uncertainty equivalent or better than ±1 month or an equivalent duration;
where the lock operation code is self-generated in a manner that can be anticipated or computed by said computing means.

48. An access control lock according to claim 47 where the said lock has an identity characteristic known to said computing means, (which may take the form of a code or a known offset of the time tracking means to an external time such as Greenwich Mean Time).

49. An access control lock according to claim 47 or 48 where the said lock operation code has a limited duration of operation, the limitation may be by time or by number of operations.

50. An access control lock according to any of claims 47 to 49 where said lock operation code is activated by said authorised person via a keypad.

51. An access control lock according to any of claims 47 to 50 where said lock operation code is activated by said authorised person via a key programmed directly or indirectly by said computing means.

52. An access control lock according to claim 51 where said key is valid for use on a limited number of occasions.

53. An access control lock according to claims 51 or 52 where said lock is unlocked by the use of said lock operation code and one of a limited number of authorisation codes.

54. An access control lock according to any of claims 47 to 53 where said lock is integral to a small box, a key safe, suitable for storing household keys.

55. An access control lock according to any of claims 52 to 54 where said key safe has a method for securely fixing it to an external wall.

56. An access control lock according to any of claims 47 to 55 where said lock can provide access to a house, shed, garage or other suitable storage location at said premises.

57. An access control lock according to any of claims 47 to 56 where said lock has a method for storing data as to whom or which key operated said lock.

58. A system for enabling the access of a suitably authorised person to a property or location at a property when the normal occupiers of the property are not present, said system including a lock and a computing means;
said lock having at least one means for unlocking with an operation code that changes;
said computing means being situated remotely from the lock and storing sufficient information to provide, directly or indirectly, said unlock code;
said authorised person with a means to input said unlock code to the lock;
where unlocking is done by the authorised person using a means or code provided directly or indirectly by said computing means.

59. A system for authorised access according to claim 58 where the said lock operation code has a limited duration of operation, the limitation may be by time or by number of operations.

60. A system for authorised access according to claim 58 or 59 where the said lock operation code is manually encoded into said lock.

61. A system for authorised access according to claim 58 or 59 where said lock operation code is encoded into said lock using a wire or wireless link.

62. A system for authorised access according to claim 58 or 59 where said lock operation code is self-generated in a manner that can be anticipated or computed by said computing means.

63. A system for authorised access according to any of claims 58 to 62 where said lock has an identity characteristic known to said computing means.

64. A system for authorised access according to any of claims 58 to 63 where said lock has a time tracking means that is or can be known to said computing means to an uncertainty equivalent to or better than ±1 month.

65. A system for authorised access according to any of claims 58 to 64 where said lock operation code is activated by said authorised person via a keypad.

66. A system for authorised access according to any of claims 58 to 64 where said lock operation code is activated by said authorised person via a key programmed directly or indirectly by said computing means.

67. A system for authorised access according to claim 64 where said key is valid for use on a limited number of occasions.

68. A system for authorised access according to claims 66 or 67 where said lock is unlocked by the use of said lock operation code and one of a limited number of authorisation codes.

69. A system for authorised access according to any of claims 58 to 68 where said lock is integral to a small box, a key safe, suitable for storing household keys.

70. A system for authorised access according to any of claims 58 to 69 where said key safe has a method for securely fixing it to an external wall.

71. A system for authorised access according to any of claims 58 to 70 where said lock provides access to a house, shed, garage or other suitable storage location at said premises.

72. A system for authorised access according to any of claims 58 to 71 where said lock has a method for storing data as to whom or which key operated said lock.

73. A system for authorised access according to any of claims 30 to 72 where said computing means operates a database or series of databases of said locks or/and said premises or said occupiers.

74. A system for authorised access according to claim 73 where said database includes a record of who could authorise access.

75. A system for authorised access according to claim 73 or 74 where said database includes at least one password or other code, which must be given to authorise access.

76. A system for authorised access according to any of claims 30 to 72 where said lock provides access for collection of material, goods or data from the property.

77. A secure home delivery system substantially as described herein with reference to FIGS. 1-3 of the accompanying drawing.
